(19) United States
(12) Patent Application Publication
(10) Pub. No.: US 2026/0001328 A1
(43) Pub. Date: Jan. 1, 2026

(54) INKJET DEVICE

(71) Applicant: Panasonic Intellectual Property Management Co., Ltd., Osaka (JP)

(72) Inventor: KAZUKI FUKADA, Osaka (JP)

(21) Appl. No.: 19/234,328

(22) Filed: Jun. 11, 2025

(30) Foreign Application Priority Data
Jun. 28, 2024 (JP) 2024-105087

(51) Int. Cl. B41J 2/14

(52) U.S. Cl. CPC B41J 2/14274; B41J 2002/14306

(57) ABSTRACT

Provided is a partition wall that served as a wall of a pressure chamber, the pressure chamber storing ink to be ejected from a nozzle; a diaphragm that presses the pressure chamber; a first piezoelectric element arranged on a portion of the diaphragm, the portion corresponding to the pressure chamber; a second piezoelectric element arranged on a portion of the diaphragm, the portion corresponding to the partition wall; and a first vibration damper provided between the first piezoelectric element and the second piezoelectric element, the first vibration damper being in contact with the diaphragm to reduce residual vibration of the diaphragm.

### BACKGROUND

### 1. Technical Field

The present disclosure relates to an inkjet device.

### 2. Description of the Related Art

In recent years, printed electronics for forming electronic devices by on-demand inkjet have been expanding.

Manufacturing an electronic device needs to convert various materials into ink, and development of a piezoelectric driving type inkjet ejection head capable of stably ejecting a wide variety of inks has been actively conducted.

For example, in the inkjet device described in Patent Literature 1, a piezoelectric element (PZT: lead zirconate titanate) deformed by application of a voltage deforms a diaphragm, which presses a pressure chamber to eject ink.

### CITATION LIST

### Patent Literature

PTL 1: Unexamined Japanese Patent Publication No. 2012-232290

### SUMMARY

At the time of ink ejection, residual vibration of the diaphragm occurs. In order to stably eject the ink, it is necessary to eject the next ink after the residual vibration of the diaphragm is settled. For this reason, there is a problem in that high-frequency ejection of ejecting ink in a short period is not stable.

Non-limiting examples of the present disclosure contribute to providing an inkjet device capable of reducing residual vibration of a diaphragm generated at the time of ink ejection.

An inkjet device according to one example of the present disclosure includes: a partition wall that serves as a wall of a pressure chamber, the pressure chamber storing ink to be ejected from a nozzle; a diaphragm that presses the pressure chamber; a first piezoelectric element arranged on a portion of the diaphragm, the portion corresponding to the pressure chamber; a second piezoelectric element arranged on a portion of the diaphragm, the portion corresponding to the partition wall; and a first vibration damper provided between the first piezoelectric element and the second piezoelectric element, the first vibration damper being in contact with the diaphragm to reduce residual vibration of the diaphragm.

According to one example of the present disclosure, it is possible to provide an inkjet device capable of reducing residual vibration of a diaphragm generated at the time of ink ejection.

Further advantages and effects in one example of the present disclosure will be clarified from the specification and the drawings. Although such advantages and/or effects are provided by several exemplary embodiments and features described in the specification and drawings, all of them are not necessarily provided to obtain one or more identical features.

### BRIEF DESCRIPTION OF THE DRAWINGS

FIG. 1 is a schematic view illustrating an appearance of an inkjet device according to a first exemplary embodiment;

FIG. 2 is an exploded perspective view illustrating an appearance of an inkjet head according to the first exemplary embodiment;

FIG. 3 is a diagram illustrating an example of a configuration of an ejection head according to the first exemplary embodiment;

FIG. 4 is a diagram illustrating an example of an XZ cross section of the ejection head according to the first exemplary embodiment;

FIG. 5 is a diagram illustrating an example of a YZ cross section of an ejection head according to a second exemplary embodiment;

FIG. 6 is a diagram illustrating an example of a YZ cross section of an ejection head according to a third exemplary embodiment;

FIG. 7 is a diagram illustrating an example of an XZ cross section of an ejection head according to a fourth exemplary embodiment; and

FIG. 8 is a diagram illustrating an example of a YZ cross section of the ejection head according to the fourth exemplary embodiment.

### DETAILED DESCRIPTIONS

Hereinafter, the exemplary embodiments of the present disclosure will be described in detail with reference to the drawings as necessary. However, unnecessary details may not be described. For example, a detailed description of an already well-known matter and a duplicated description of substantially the same configuration will be omitted in some cases. This is to avoid unnecessary redundancy of the following description and to facilitate understanding of those skilled in the art.

Note that the accompanying drawings and the following description are provided for those skilled in the art to fully understand the present disclosure, and are not intended to limit the subject matter recited in the claims.

### First Exemplary Embodiment

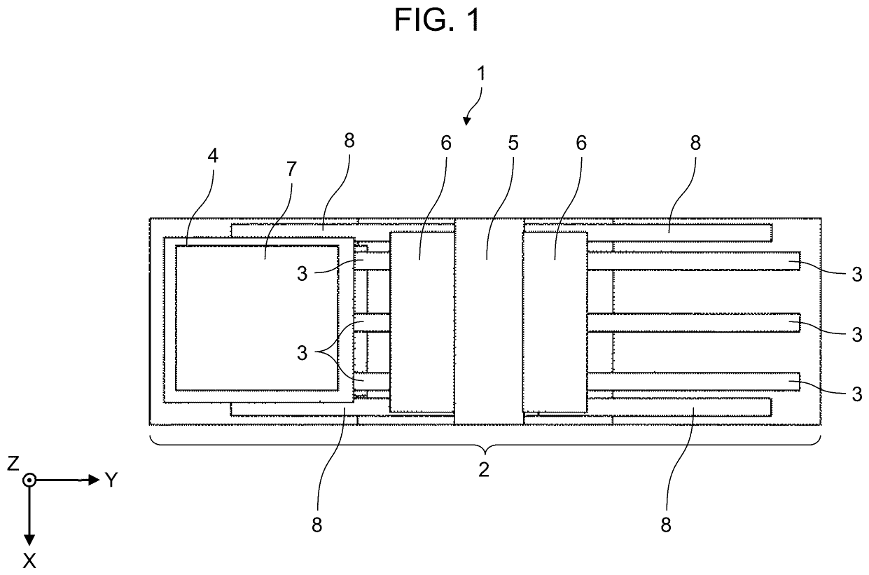

Inkjet device 1 will be described with reference to FIG. 1. FIG. 1 is a plan view of inkjet device 1 according to a first exemplary embodiment. As illustrated in FIG. 1, a lateral direction of inkjet device 1 is an X direction, a longitudinal direction thereof is a Y direction, and a direction perpendicular to the X direction and the Y direction is a Z direction.

Inkjet device 1 includes base 2, guide 3, conveyance table 4, gantry 5 having a gate shape as an example of a support member, line head 6, and drive unit 8.

Base 2 is formed of a rectangular parallelepiped having a rectangular planar shape elongated in the scanning direction.

Guide 3 is fixed to the upper surface of base 2 along the longitudinal direction (Y direction) of base 2, that is, the scanning direction. As an example, guide 3 is formed of a rectangular parallelepiped shape member having a rectangular cross section along a direction orthogonal to the scanning direction.

Conveyance table 4 has a rectangular shape, and the lower surface (the surface on the −Z side) thereof is in contact with guide 3. Conveyance table 4 is guided by guide 3 and conveyed in the scanning direction of base 2. Printing target object 7 such as a substrate is placed on conveyance table 4.

Gantry 5 has a gate shape, and is fixed at a predetermined position, for example, an intermediate position of base 2 so as to straddle base 2 in the lateral direction in a plan view (when viewed from the +Z side).

Line head 6 is an example of an ejection head, and is supported by gantry 5. Line head 6 ejects ink toward conveyance table 4 in accordance with the timing at which conveyance table 4 passes under line head 6. The ink is applied to the application region of printing target object 7 placed on conveyance table 4.

Note that, in this configuration, as illustrated in FIG. 1, line head 6 has a configuration in which two types of line heads 6 are each arranged on a respective one of both surfaces of gantry 5, but only one line head 6 may be arranged on gantry 5, or two gantries 5 may be arranged and a total of four line heads 6, each of which is arranged on a respective one of both surfaces of each gantry 5, may be arranged. The configuration such as the number and arrangement of line heads 6 may be changed according to the process desired to be performed by line head 6 with respect to printing target object 7.

Furthermore, in order to drive conveyance table 4 in the scanning direction, at least one or more drive units 8 are arranged on base 2 along the scanning direction and connected to conveyance table 4, so that conveyance table 4 can be conveyed and driven in the scanning direction.

In FIG. 1, as an example of drive unit 8, two drive units 8 are arranged on base 2 along the scanning direction in the vicinity of both ends in the lateral direction of inkjet device 1. Each drive unit 8 may be a linear motor, or may be a ball screw or the like connected to a rotary motor. In the present configuration, drive unit 8 using a linear motor is exemplified.

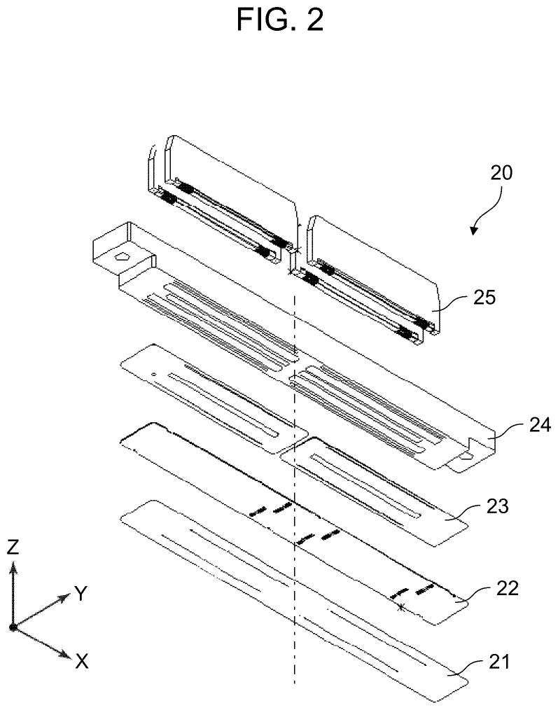

Ejection head 20 will be described with reference to FIG. 2. FIG. 2 is an exploded perspective view illustrating an appearance of ejection head 20 according to the first exemplary embodiment. As illustrated in FIG. 2, a longitudinal direction of ejection head 20 is an X direction, a lateral direction thereof is a Y direction, and a direction perpendicular to the X direction and the Y direction is a Z direction.

As illustrated in FIG. 2, ejection head 20 includes nozzle plate 21, channel plate 22, diaphragm 23, housing 24, and pressure fluctuation unit 25.

Nozzle plate 21 is disposed so that the plate surface is orthogonal to the Z direction. Nozzle plate 21 is made of, for example, a stainless steel plate molded by etching or press working. The thickness of the stainless steel plate is, for example, 100 micrometers. In nozzle plate 21, nozzles 34 for ejecting ink are formed along the Y direction.

Channel plate 22 has a rectangular parallelepiped shape, and is disposed on the +Z side of nozzle plate 21 so that the plate surface is orthogonal to the Z direction. Channel plate 22 is sandwiched between diaphragm 23 and nozzle plate 21. Channel plate 22 is, for example, a laminate of stainless steel plates molded by etching or press working. The thickness of each stainless steel plate is, for example, 10 micrometers to 100 micrometers, and a number of laminated layers is, for example, 3 layers to 10 layers.

Diaphragm 23 is disposed on the +Z side of channel plate 22 so that a plate surface is orthogonal to the Z direction. Diaphragm 23 is sandwiched between housing 24 and channel plate 22. Diaphragm 23 is, for example, a thin film having a thickness of 5 micrometers to 50 micrometers, and is manufactured by, for example, electroplating of a nickel alloy.

Housing 24 has a rectangular parallelepiped shape and is disposed on the +Z side of diaphragm 23. Housing 24 has a thickness of 1 centimeter in the Z direction, for example. Housing 24 is manufactured by, for example, cutting alloy steel such as stainless steel.

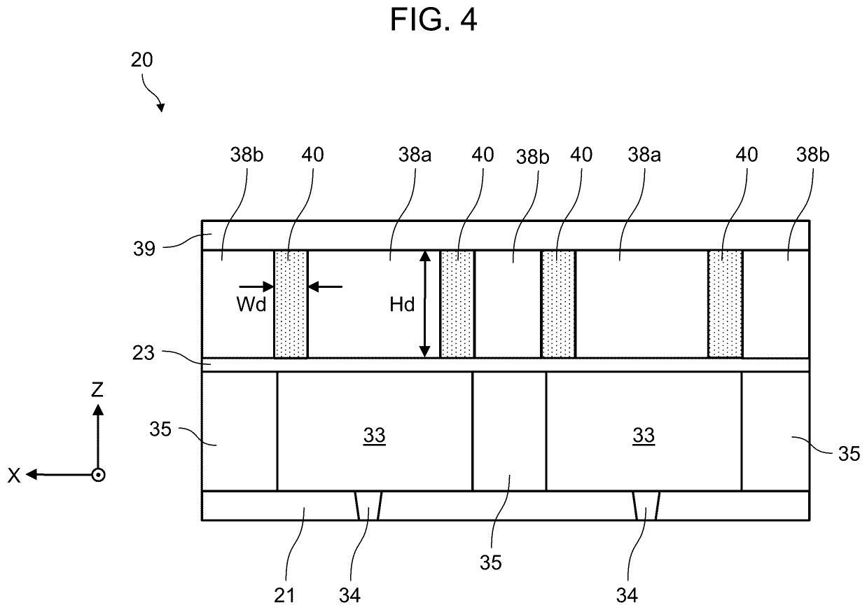

Pressure fluctuation unit 25 is housed in housing 24 and pressurizes the ink stored in pressure chamber 33 to generate pressure fluctuation. Pressure fluctuation unit 25 includes, for example, a control board on which a control IC and the like are mounted, and the control board individually controls voltages applied to first piezoelectric element 38a and second piezoelectric element 38b illustrated in FIG. 4 and the like.

A space between nozzle plate 21 and channel plate 22, a space between channel plate 22 and diaphragm 23, a space between diaphragm 23 and housing 24, and a space between diaphragm 23 and pressure fluctuation unit 25 are each bonded and fixed with an adhesive. Available examples of the adhesive include an epoxy-based adhesive having thermosetting characteristics. Note that the adhesives for bonding the respective components may be identical or different. For example, a rubber-based adhesive and an epoxy-based adhesive may be used in combination.

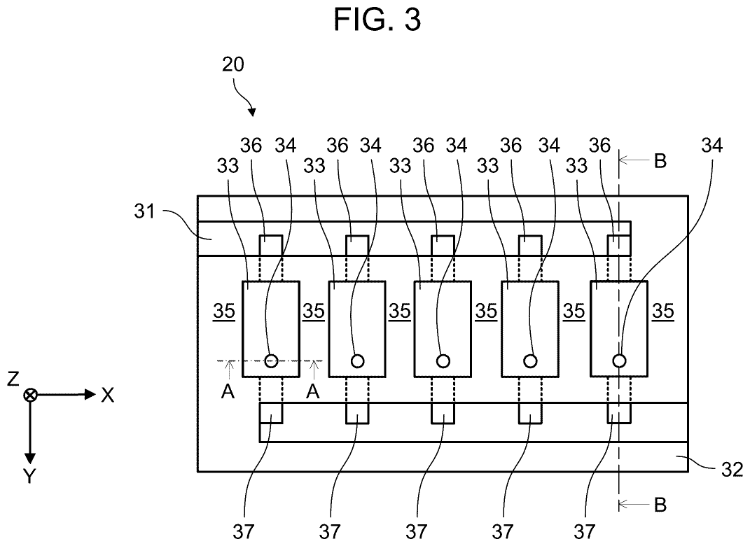

A schematic configuration of ejection head 20 will be described with reference to FIG. 3. FIG. 3 is a diagram illustrating an example of a configuration of ejection head 20 according to the first exemplary embodiment.

Ejection head 20 includes ink supply channel 31, ink discharge channel 32, pressure chamber 33, nozzle 34, partition wall 35, ink inlet channel 36, and ink outlet channel 37.

Ink supply channel 31 and ink discharge channel 32 are arranged along the X direction of ejection head 20. Furthermore, Ink supply channel 31 and ink discharge channel 32 are arranged to face each other in the Y direction of ejection head 20.

Pressure chamber 33 is arranged between ink supply channel 31 and ink discharge channel 32. A plurality of pressure chambers 33 are arranged in the X direction.

The ink supplied to ink supply channel 31 is supplied to pressure chamber 33 through ink inlet channel 36 communicating with pressure chamber 33 by the negative pressure generated in pressure chamber 33 when first piezoelectric element 38a and second piezoelectric element 38b contract from the extended state. A part of the ink supplied to pressure chamber 33 is ejected from nozzle 34 by pressurization to pressure chamber 33 by extension of first piezoelectric element 38a and second piezoelectric element 38b, and the rest is discharged to ink discharge channel 32 through ink outlet channel 37 communicating with pressure chamber 33. The ink in ink discharge channel 32 is supplied to ink supply channel 31 again.

Nozzle 34 is a through hole provided in nozzle plate 21, and communicates the inside and the outside of pressure chamber 33. Nozzle 34 is provided corresponding to pressure chamber 33. Furthermore, the ink is ejected from nozzle 34 in the −Z direction.

Furthermore, nozzle 34 is provided on the side of ink outlet channel 37 (+Y side) of pressure chamber 33 in the Y direction. Such a configuration is effective for smoothly ejecting the ink from nozzle 34 and discharging the ink to ink outlet channel 37.

A plurality of partition walls 35 are arranged in the X direction. Partition wall 35 separates pressure chamber 33 that stores the ink ejected from nozzle 34.

A schematic configuration of ejection head 20 in the XZ cross section will be described with reference to FIG. 4. FIG. 4 is a view (for example, a cross-sectional view taken along line A-A in FIG. 3) illustrating an example of the XZ cross section of ejection head 20 according to the first exemplary embodiment.

Pressure chamber 33 includes nozzle plate 21, partition wall 35, and diaphragm 23. Nozzle plate 21 constitutes a lower (−Z side) wall of pressure chamber 33. Partition wall 35 constitutes left (+X side) and right (−X side) walls of pressure chamber 33. Diaphragm 23 constitutes an upper (+Z side) wall of pressure chamber 33.

A plurality of first piezoelectric elements 38a and a plurality of second piezoelectric elements 38b are alternately arranged in the X direction. First piezoelectric element 38a is arranged in a portion corresponding to pressure chamber 33 of diaphragm 23. First piezoelectric element 38a presses a portion corresponding to pressure chamber 33 of diaphragm 23.

Second piezoelectric element 38b is arranged in a portion corresponding to partition wall 35 of diaphragm 23. Second piezoelectric element 38b supports a portion corresponding to partition wall 35 of diaphragm 23.

Base portion 39 fixes the plurality of first piezoelectric elements 38a and the plurality of second piezoelectric elements 38b arranged in the X direction on the side opposite to diaphragm 23. For example, base portion 39 has the same composition as first piezoelectric element 38a and second piezoelectric element 38b, and is integrally molded with first piezoelectric element 38a and second piezoelectric element 38b.

Vibration damper 40 (first vibration damper) is provided between first piezoelectric element 38a and second piezoelectric element 38b, and is in contact with diaphragm 23 to reduce residual vibration of diaphragm 23 generated at the time of ink ejection of inkjet device 1. Note that vibration damper 40 may be referred to as a vibration absorber, a vibration relaxation part, a damper, or the like.

Furthermore, as illustrated in FIG. 4, in a case where the width in the X direction of vibration damper 40 is Wd and the height in the Z direction thereof is Hd, the Wd is preferably between 10 micrometers and 200 micrometers, inclusive. In addition, the Hd is preferably between 0.01 micrometers and 5 millimeters, inclusive.

With this configuration, the residual vibration of diaphragm 23 at the time of ejecting the ink can be reduced. Therefore, the time during which the residual vibration of diaphragm 23 is settled is shortened, and inkjet device 1 can stably eject the ink at a high frequency.

### Second Exemplary Embodiment

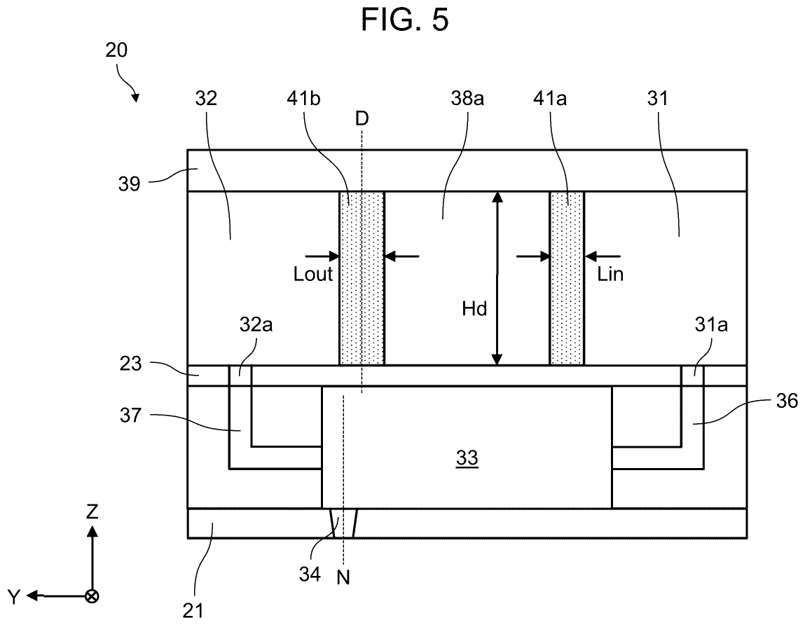

A schematic configuration of ejection head 20 according to a second exemplary embodiment in the YZ cross section will be described with reference to FIG. 5. FIG. 5 is a view (for example, a cross-sectional view taken along line B-B in FIG. 3) illustrating an example of the YZ cross section of ejection head 20 according to the second exemplary embodiment.

In the present exemplary embodiment, each of vibration damper 41a (second vibration damper) and vibration damper 41b (third vibration damper) is arranged on the +Z side in the vicinity of both ends of pressure chamber 33 in the Y direction.

Vibration damper 41a is provided on the side of ink supply channel 31 that supplies ink to pressure chamber 33 of first piezoelectric element 38a, and contacts diaphragm 23 to reduce residual vibration of diaphragm 23, the residual vibration being generated in the vicinity of ink inlet channel 36 at the time of ink ejection of inkjet device 1.

Vibration damper 41b is provided on the side of ink discharge channel 32 that discharges ink from pressure chamber 33 of first piezoelectric element 38a, and contacts diaphragm 23 to reduce residual vibration of diaphragm 23, the residual vibration being generated in the vicinity of ink outlet channel 37 at the time of ink ejection of inkjet device 1. Furthermore, vibration damper 41b is arranged so that its center D in the X direction is shifted from the center N of nozzle 34 in the X direction.

Ink supply channel 31 and ink inlet channel 36 communicate with each other through hole 31a formed in diaphragm 23, and the ink supplied to ink supply channel 31 passes through ink inlet channel 36 through hole 31a and is supplied to pressure chamber 33.

Ink discharge channel 32 and ink outlet channel 37 communicate with each other through hole 32a formed in diaphragm 23, and the ink discharged from pressure chamber 33 to ink outlet channel 37 passes through ink discharge channel 32 through hole 32a and is discharged from ejection head 20.

The residual vibration generated in diaphragm 23 increases in the vicinity of both ends in the Y direction of pressure chamber 33 due to the reflection of the pressure wave in pressure chamber 33 generated at the time of ink ejection by inkjet device 1. That is, the residual vibration of diaphragm 23 increases in the vicinity of ink inlet channel 36 arranged at one end of pressure chamber 33 and in the vicinity of ink outlet channel 37 arranged at the other end of pressure chamber 33.

Since vibration damper 41a and vibration damper 41b are arranged corresponding to a portion where the residual vibration of diaphragm 23 increases, the residual vibration of diaphragm 23 can be efficiently reduced.

Furthermore, among both ends of pressure chamber 33 in the Y direction, the residual vibration of diaphragm 23 is larger in the vicinity of ink outlet channel 37 close to nozzle 34 from which the ink is discharged than in the vicinity of ink inlet channel 36.

Therefore, vibration damper 41b is provided closer to nozzle 34 than vibration damper 41a, and the width Lout in the Y direction of vibration damper 41b in the Y direction (first direction) in which vibration damper 41b faces vibration damper 41a is larger than the width Lin in the Y direction of vibration damper 41a (Lout>Lin).

Furthermore, the width Lin of vibration damper 41a is preferably between 10 micrometers and 200 micrometers, inclusive. In addition, the width Lout of vibration damper 41b is preferably between 20 micrometers and 400 micrometers, inclusive.

In the second exemplary embodiment, each of vibration dampers 41a, 41b is arranged in the vicinity of both ends of pressure chamber 33 in the Y direction. As a result, it is possible to efficiently reduce the residual vibration of diaphragm 23 in the vicinity of ink inlet channel 36 and ink outlet channel 37 connected to pressure chamber 33 in which large residual vibration is likely to occur.

### Third Exemplary Embodiment

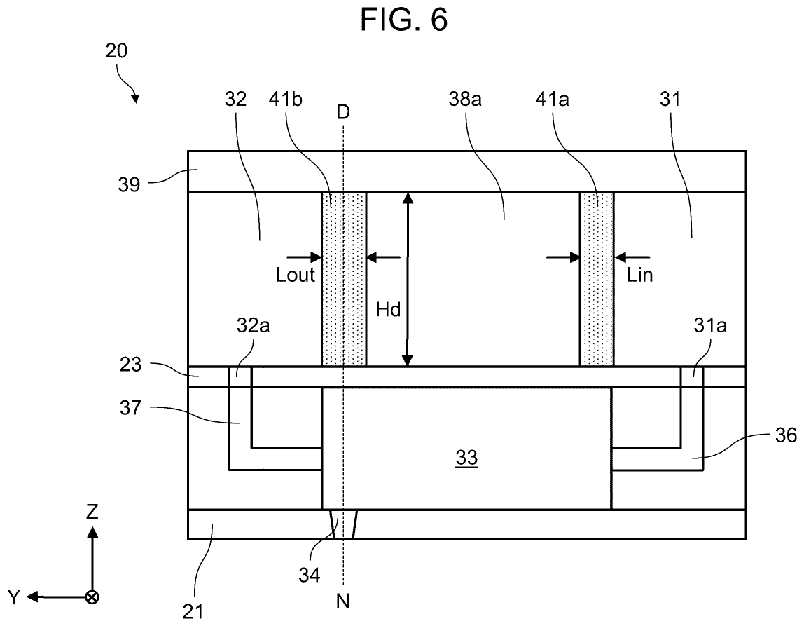

A schematic configuration of ejection head 20 according to a third exemplary embodiment in the YZ cross section will be described with reference to FIG. 6. FIG. 6 is a view (for example, a cross-sectional view taken along line B-B in FIG. 3) illustrating an example of the YZ cross section of ejection head 20 according to the third exemplary embodiment.

In the third exemplary embodiment, unlike the second exemplary embodiment, vibration damper 41b is arranged so that its own center D in the Y direction coincides with the center N of nozzle 34 in the Y direction.

In the third exemplary embodiment, since the center D of vibration damper 41b and the center N of nozzle 34 coincide with each other in the Y direction, it is possible to efficiently reduce residual vibration of diaphragm 23 in the vicinity of ink outlet channel 37, the residual vibration tending to become large due to ink ejection.

### Fourth Exemplary Embodiment

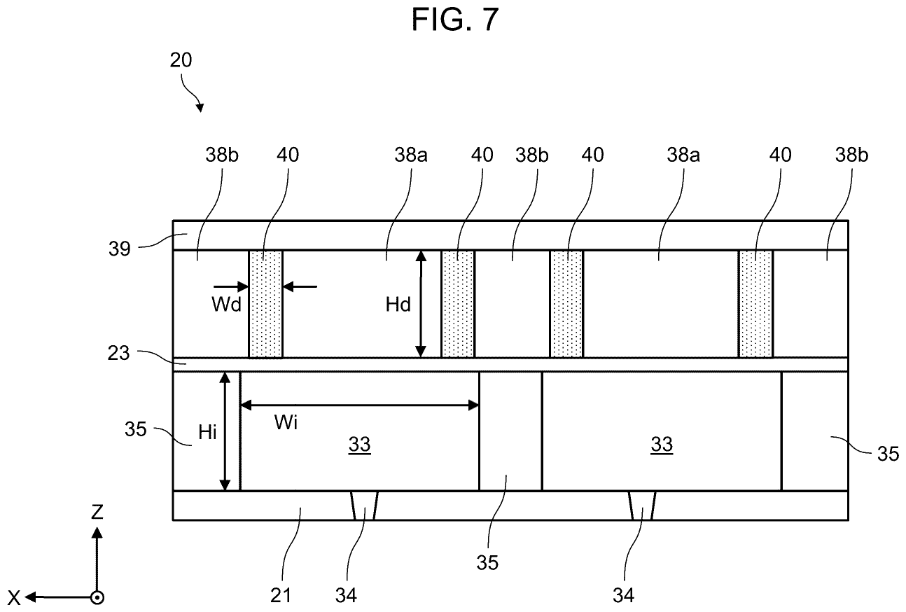

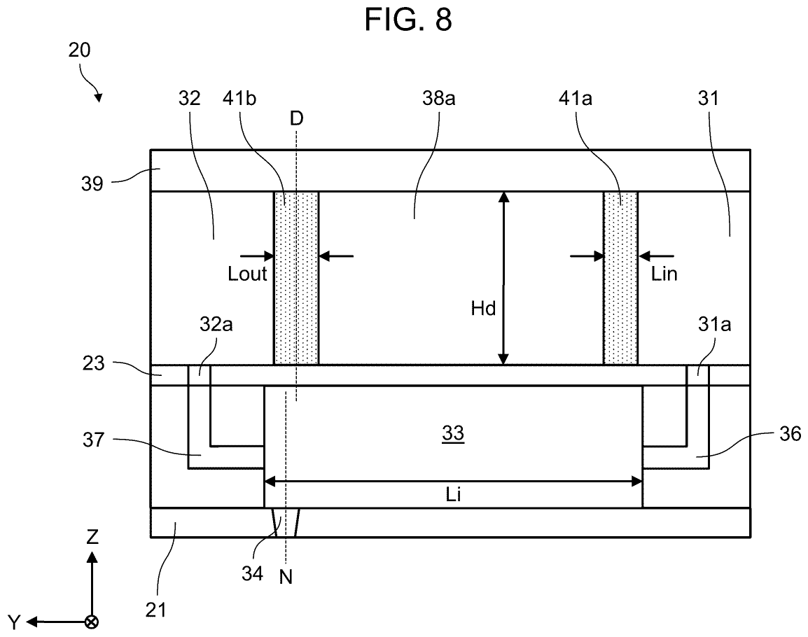

A schematic configuration of ejection head 20 according to a fourth exemplary embodiment in the XZ cross section will be described with reference to FIGS. 7 and 8. FIG. 7 is a view (for example, a cross-sectional view taken along line A-A in FIG. 4) illustrating an example of the XZ cross section of ejection head 20 according to the fourth exemplary embodiment. FIG. 8 is a view (for example, a cross-sectional view taken along line B-B in FIG. 3) illustrating an example of the YZ cross section of ejection head 20 according to the fourth exemplary embodiment.

In the fourth exemplary embodiment, the width of pressure chamber 33 in the X direction is formed so as to be longer than the width in the related art. Specifically, the width Wi of pressure chamber 33 in the X direction is larger than or equal to the height Hi in the Z direction. In other words, the ratio (Wi/Hi) of the width Wi of pressure chamber 33 to the height Hi of pressure chamber 33 in the X direction (second direction) in which first piezoelectric element 38a and second piezoelectric element 38b face each other is greater than or equal to 1. As a result, since the resonance cycle of pressure chamber 33 becomes longer than the resonance cycle in the related art, inkjet device 1 can eject more ink by one ejection.

In a case where the width in the X direction of vibration damper 40 illustrated in FIG. 7 is Wd and the height in the Z direction thereof is Hd, the width Wd of vibration damper 40 is preferably between 10 micrometers and 200 micrometers, inclusive. Furthermore, the height Hd of vibration damper 40 is preferably between 0.01 micrometers and 5 millimeters, inclusive.

In addition, in a case where the width in the X direction of pressure chamber 33 illustrated in FIG. 7 is Wi and the height in the Z direction thereof is Hi, the width Wi of pressure chamber 33 is preferably between 50 micrometers and 700 micrometers, inclusive. In addition, the height Hi of pressure chamber 33 is preferably between 50 micrometers and 500 micrometers, inclusive.

In addition, the ratio (Wi/Wd) of the width Wi of pressure chamber 33 to the width Wd of vibration damper 40 is preferably between 4 and 20, inclusive. In addition, the ratio of the width Wi of pressure chamber 33 to the height Hi of pressure chamber 33 is preferably between 1 and 5, inclusive.

In addition, in a case where the width in the Y direction of vibration damper 41a illustrated in FIG. 8 is Lin and the width in the Y direction of vibration damper 41b is Lout, the width Lin of vibration damper 41a is preferably between 10 micrometers and 200 micrometers, inclusive. In addition, the width Lout of vibration damper 41b is preferably between 20 micrometers and 400 micrometers, inclusive.

In addition, the ratio (Lout/Lin) of the width Lout of vibration damper 41b to the width Lin of vibration damper 41a is preferably between 1 and 5, inclusive.

In the fourth exemplary embodiment, since pressure chamber 33 is formed so as to have a large volume, the area of diaphragm 23 that deforms when inkjet device 1 ejects ink is larger than the area in the related art. Thus, inkjet device 1 can suppress the magnitude of deformation of diaphragm 23 at the time of ink ejection. As a result, the residual vibration of diaphragm 23 decreases, and the effect of reducing the residual vibration by vibration dampers 40, 41a, 41b increases.

Note that vibration damper 41b may be configured to be arranged so that its center D in the Y direction coincides with the center N of nozzle 34 in the Y direction. In this case, vibration dampers 40, 41a, 41b can more efficiently reduce the residual vibration of diaphragm 23.

### SUMMARY OF EXEMPLARY EMBODIMENTS

As described above, an inkjet device of the present exemplary embodiment includes: a partition wall that served as a wall of a pressure chamber, the pressure chamber storing ink ejected from a nozzle; a diaphragm that presses the pressure chamber; a first piezoelectric element arranged on a portion of the diaphragm, the portion corresponding to the pressure chamber; a second piezoelectric element arranged on a portion of the diaphragm, the portion corresponding to the partition wall; and a first vibration damper provided between the first piezoelectric element and the second piezoelectric element, the first vibration damper being in contact with the diaphragm to reduce residual vibration of the diaphragm.

With this configuration, the residual vibration of diaphragm 23 generated at the time of ejecting the ink of inkjet device 1 can be efficiently reduced. Therefore, the time during which the residual vibration of diaphragm 23 is settled is shortened, and inkjet device 1 can stably eject the ink at a high frequency.

Vibration dampers 40, 41a, and 41b include, for example, an elastomer material (liquid fluorine, silicone, urethane, epoxy, and the like). Furthermore, vibration dampers 40, 41a, 41b are manufactured by, for example, two-liquid adhesion, room temperature curing, UV curing, and thermal curing (less than or equal to 100 degrees). In addition, characteristics of vibration damper 40 are, for example, a penetration of 70 (JIS K-2220, ¼ cone) and a viscosity of 3 Pa·s. Preferably, the penetration is between 20 and 200, inclusive, and the viscosity is 50 Pa·s.

The expression, “ . . . part”, used for each component in the above-described exemplary embodiments may be replaced with another expression such as “ . . . assembly”, “ . . . device”, “ . . . unit”, or “ . . . module”.

Although the exemplary embodiments have been described with reference to the accompanying drawings, the present disclosure is not limited to the examples. It is apparent that those skilled in the art could easily conceive of various changes or modifications within the scope of the claims. Such changes or modifications are also understood to belong to the technical scope of the present disclosure. Furthermore, within a range without departing from the gist of the present disclosure, the components according to the exemplary embodiments may be combined as appropriate.

The present disclosure is useful as an inkjet device.

What is claimed is:

1. An inkjet device comprising:
a partition wall that serves as a wall of a pressure chamber, the pressure chamber storing ink to be ejected from a nozzle;
a diaphragm that presses the pressure chamber;
a first piezoelectric element arranged on a portion of the diaphragm, the portion corresponding to the pressure chamber;
a second piezoelectric element arranged on a portion of the diaphragm, the portion corresponding to the partition wall; and
a first vibration damper provided between the first piezoelectric element and the second piezoelectric element, the first vibration damper being in contact with the diaphragm to reduce residual vibration of the diaphragm.

2. The inkjet device according to claim 1, further comprising:
an ink supply channel through which ink is supplied to the pressure chamber;
an ink discharge channel through which ink is discharged from the pressure chamber;
a second vibration damper provided on a side of the first piezoelectric element, the side being closer to the ink supply channel than to the ink discharge channel, the second vibration damper being in contact with the diaphragm to reduce the residual vibration of the diaphragm; and
a third vibration damper provided on a side of the first piezoelectric element, the side being closer to the ink discharge channel than to the ink supply channel, the third vibration damper being in contact with the diaphragm to reduce the residual vibration of the diaphragm.

3. The inkjet device according to claim 2, wherein
the third vibration damper is provided closer to the nozzle than the second vibration damper is,
the third vibration damper faces the second vibration damper in a first direction, and
the third vibration damper has a width in the first direction that is greater than a width of the second vibration damper in the first direction.

4. The inkjet device according to claim 3, wherein
the third vibration damper has a center in the first direction that coincides with a center of the nozzle in the first direction.

5. The inkjet device according to claim 1, wherein
the first piezoelectric element faces the second piezoelectric element in a second direction, and
a ratio of a width of the pressure chamber in the second direction to a height of the pressure chamber is greater than or equal to 1.

6. The inkjet device according to claim 1, wherein
the first vibration damper includes an elastomer material.
